(19) United States
(12) Patent Application Publication
(10) Pub. No.: US 2013/0167336 A1
(43) Pub. Date: Jul. 4, 2013

(54) Casket Dome Lid

(71) Applicant: C.J. Boots, LLC, Anderson, IN (US)

(72) Inventors: Christopher J. Boots, Pendleton, IN (US); Justin F. Davis, Noblesville, IN (US)

(73) Assignee: C.J. BOOTS, LLC, Anderson, IN (US)

(21) Appl. No.: 13/657,832

(22) Filed: Oct. 22, 2012

Related U.S. Application Data
(60) Provisional application No. 61/550,117, filed on Oct. 21, 2011.

(51) Int. Cl. A61G 17/02

(52) U.S. Cl. CPC A61G 17/02
USPC 27/14; 29/428

(57) ABSTRACT

A lid for a casket includes a panel, a first end portion and a second end portion. The panel extends over the casket. The panel defines a length. The panel includes an underside which faces toward the casket. The panel includes a plurality of scores cut into the underside which extend along the length to facilitate bending the panel into an arced shape. The first end portion is coupled to a first end of the panel. The second end portion is coupled to a second end of the panel.

### FIELD

This application relates to the field of lid assemblies for caskets and methods of assembling lid assemblies for caskets.

### BACKGROUND

Burial or cremation containers, referred to herein collectively as caskets, represent an expensive element of a traditional funeral. Costs associated with traditional caskets are attributable in significant part to the material and labor cost of forming a traditional casket of stained wood or metal material. Accordingly, one way to reduce casket (and hence funeral) costs includes the use of caskets made from alternative materials, such as paperboard, unfinished wood and composite materials. Such caskets are particularly suitable for cremation. However, caskets constructed of alternative materials often do not provide as pleasing a presentation of the deceased during a wake or viewing. While advances in the construction of caskets made from alternative materials have resulted in aesthetic improvements, such caskets still lack the aesthetic appeal of traditional caskets.

One solution to the countervailing tensions of reducing cost and retaining aesthetic appeal of caskets involves making caskets out of alternative materials that look more like traditional caskets. To keep costs low, the caskets made from alternative materials must be easy to produce, requiring few materials and reduced labor. Additionally, the caskets made from alternative materials must look and function like traditional caskets. Making more aesthetically pleasing caskets from alternative materials may include making a casket lid from alternative materials. Such a casket lid must be provided in a form which enables the lid to fit over the casket for use and provides an efficient shape to accommodate the deceased within the casket. To function as a traditional casket lid, the casket lid made from alternative materials must have sufficient structural integrity to withstand pressure applied to the top of the casket during use.

There is a need, therefore, for a casket formed out of alternative materials that addresses the needs for reduced cost and aesthetically pleasing presentation without inherent difficulties associated with known caskets formed out of alternative materials. It would be advantageous if this casket formed out of alternative materials required few materials and reduced labor. It would also be advantageous if this casket formed out of alternative materials looked and functioned as a traditional casket.

### SUMMARY

In accordance with one embodiment of the disclosure, there is provided a lid for a casket including a panel, a first end portion and a second end portion. The panel extends over the casket. The panel defines a length. The panel includes an underside which faces toward the casket. The panel includes a plurality of scores cut into the underside which extend along the length to facilitate bending the panel into an arced shape. The first end portion is coupled to a first end of the panel. The second end portion is coupled to a second end of the panel.

In accordance with another embodiment of the disclosure, there is provided a method of assembling a lid for a casket. The method includes preparing a panel assembly and preparing a frame assembly. The frame assembly includes a first frame side, a second frame side and a first frame end. The method further includes inserting the panel assembly into the frame assembly and coupling a second frame end to the frame assembly.

The above described features and advantages, as well as others, will become more readily apparent to those of ordinary skill in the art by reference to the following detailed description and accompanying drawings. While it would be desirable to provide a lid for a casket that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1A depicts a top left perspective view of a casket assembly including a base portion and a lid.

FIG. 1B depicts a side elevational view of the casket assembly of FIG. 1A.

FIG. 1C depicts a front elevational view of the casket assembly of FIG. 1A.

FIG. 2A depicts a top left perspective view of the lid of the casket assembly of FIG. 1A including a panel assembly and a frame assembly.

FIG. 2B depicts a side elevational view of the lid of FIG. 2A.

FIG. 2C depicts a front elevational view of the lid of FIG. 2A.

FIG. 3A depicts a bottom right perspective view of the foot panel portion of the panel assembly of FIGS. 2A-2C, wherein the foot panel portion has not been assembled onto the foot frame portion of the assembly of FIGS. 2A-2C.

FIG. 3B depicts a bottom left perspective view of the head panel portion of the panel assembly of FIGS. 2A-2C, wherein the head panel portion has not been assembled onto the head frame portion of FIGS. 2A-2C.

FIG. 4A depicts a bottom left perspective view of a foot panel of the foot panel portion of FIG. 3A, wherein the foot panel has not been assembled onto the foot panel portion of FIG. 3A.

FIG. 4B depicts a bottom right perspective view of a head panel of the head panel portion of FIG. 3B, wherein the head panel has not been assembled onto the head panel portion of FIG. 3B.

FIG. 5 depicts a fragmentary cross-sectional view of the foot panel of FIG. 4A.

FIG. 6 depicts a fragmentary cross-sectional view of the lid of FIGS. 2A-2C.

FIG. 7 depicts a top left perspective view of a support of the panel assembly of FIGS. 2A-2C.

FIG. 8 depicts an end elevational view of a brace of the panel assembly of FIGS. 2A-2C.

FIG. 9 depicts a top left perspective view of a foot frame portion of the frame assembly of FIGS. 2A-2C.

FIG. 10 depicts a top left perspective view of the foot panel portion of FIG. 3A inserted into the foot frame portion of FIG. 9.

FIG. 11A depicts a top left perspective view of an alternative lid including a panel assembly, a frame assembly and a separate frame end.

FIG. 11B depicts a right side elevational view of the lid of FIG. 11A.

FIG. 11C depicts a front elevational view of the lid of FIG. 11A.

FIGS. 12A-12K depict steps of a method for constructing the lid of FIGS. 2A-2C.

### DESCRIPTION

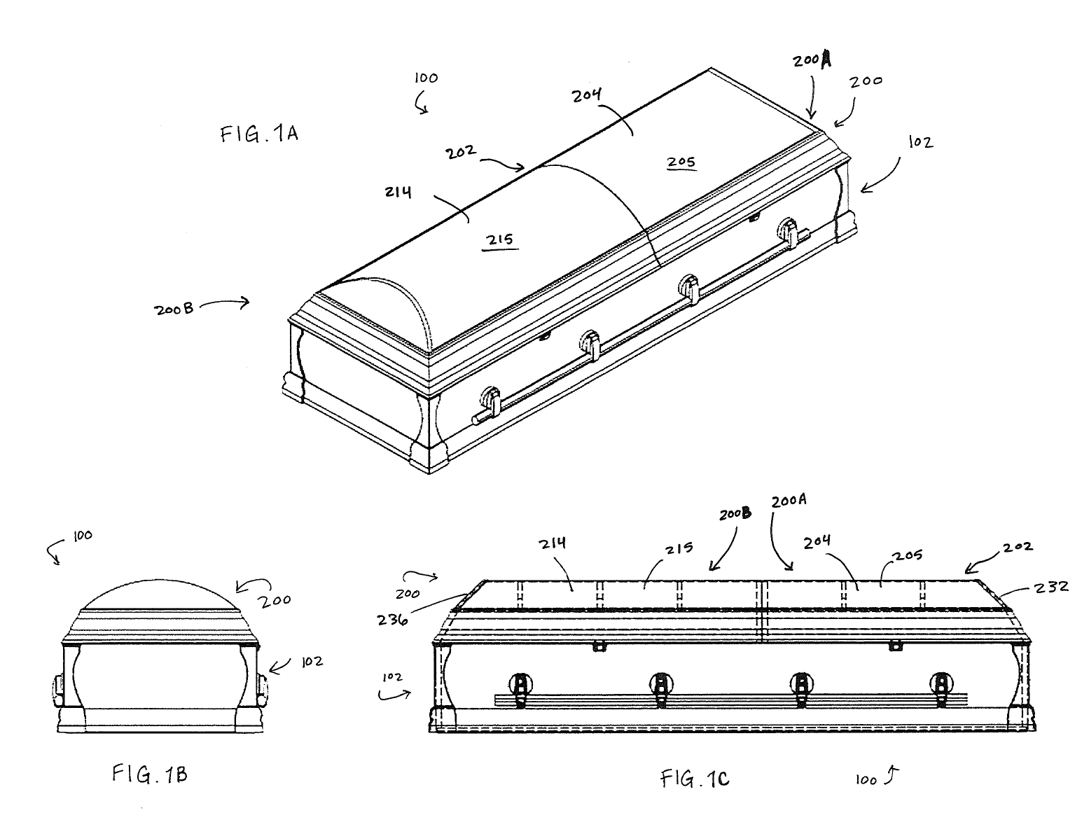

FIGS. 1A-1C depict a perspective view, an end plan view and a front plan view, respectively, of an exemplary casket assembly 100 that incorporates embodiments of the invention. The casket assembly 100 includes a base portion 102 and a lid 200. The lid 200 is configured to fit over the base portion 102 when the deceased is contained within the base portion 102. The lid 200 is generally arced or dome shaped to accommodate the deceased.

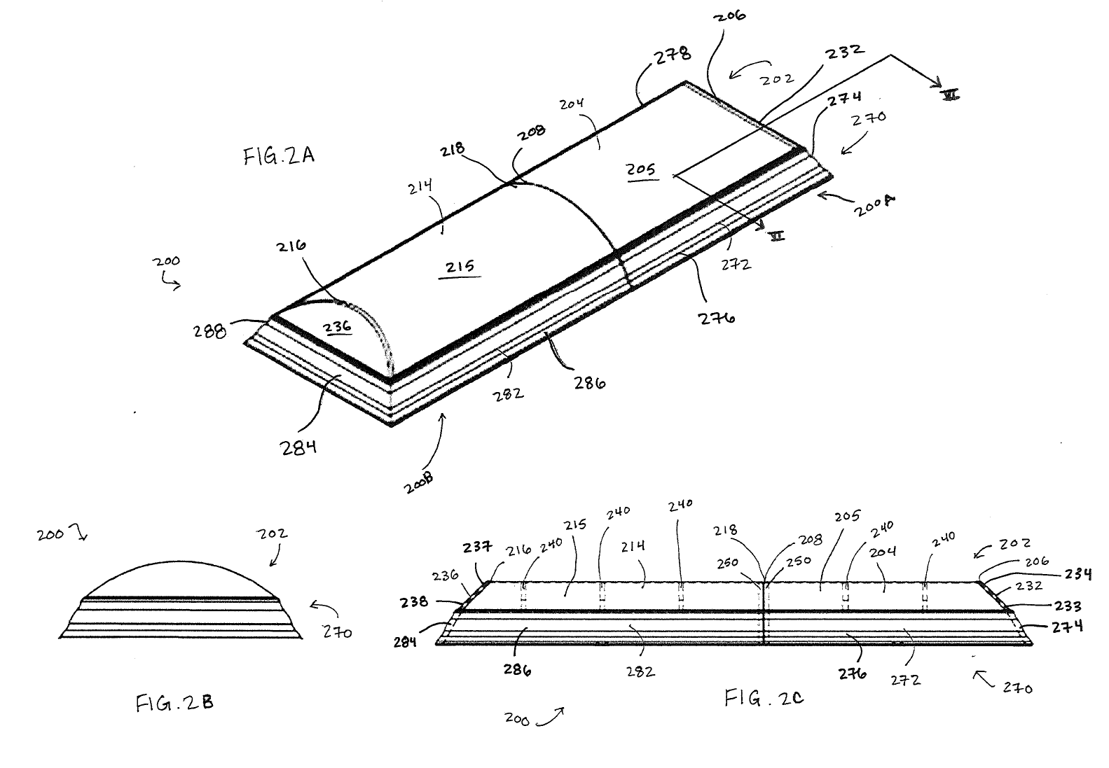

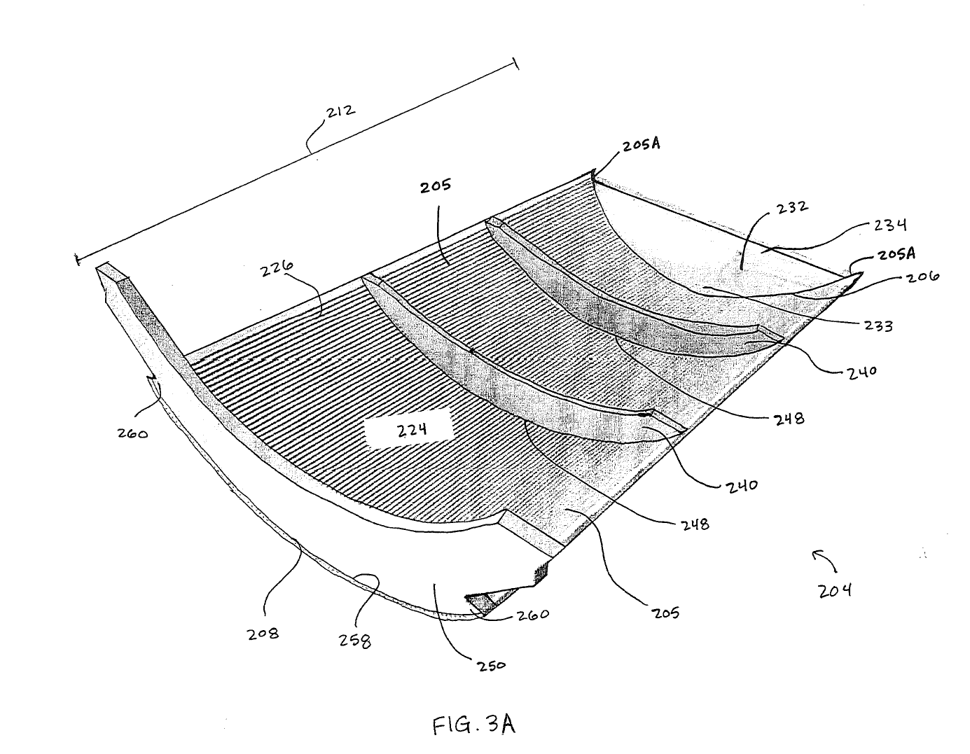

FIGS. 2A-2C depict a perspective view, an end plan view and a front plan view, respectively, of the lid 200. The lid 200 includes a panel assembly 202 and a frame assembly 270. As shown in FIG. 2C, the panel assembly 202 includes a foot panel portion 204 and a head panel portion 214. The frame assembly 270 includes a foot frame portion 272 and a head frame portion 282. The panel assembly 202 is coupled to the frame assembly 270, as described below, to form the lid 200. As will be discussed below in detail, the foot panel portion 204 and the foot frame portion 272 cooperate to form a foot lid 200A (shown in FIGS. 2A-2C). Similarly, the head panel portion 214 and the head frame portion 282 cooperate to form a head lid 200B (shown in FIGS. 2A-2C). The foot lid 200A and the head lid 200B combine to form the lid 200.

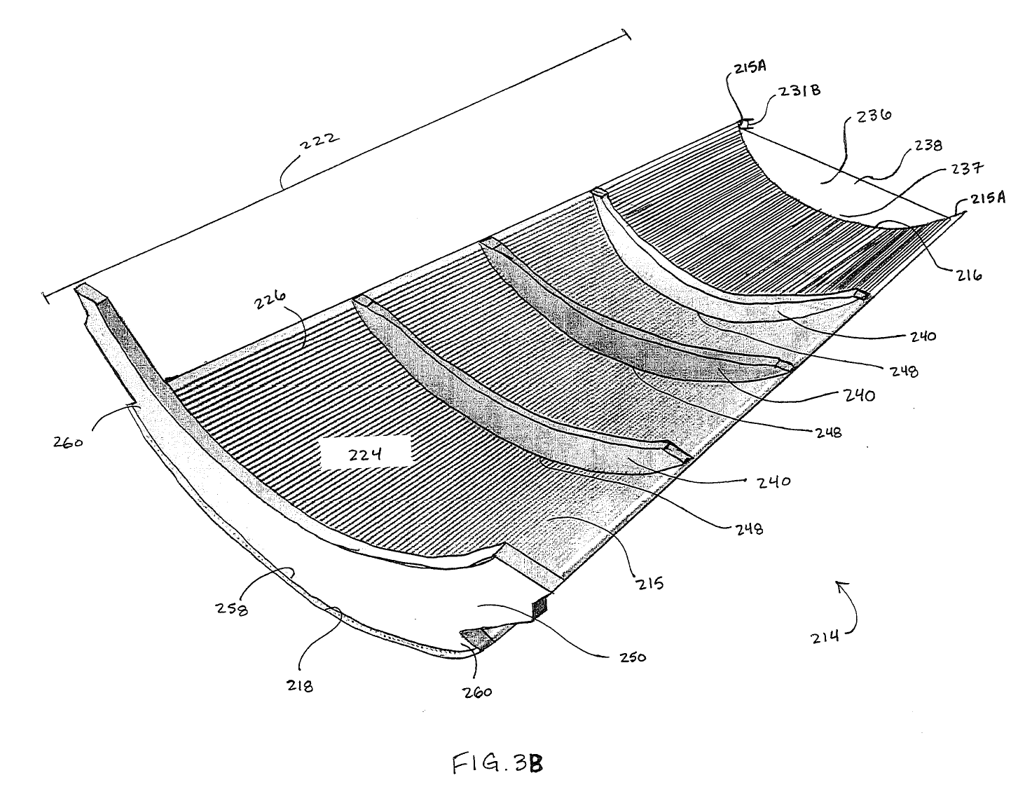

The assembly and structure of the foot panel portion 204 and head panel portion 214 are provided below in connection with, respectively, FIG. 3A and FIG. 3B. The assembly and structure of the foot frame portion 272 and head frame portion 282 are thereafter described in connection with FIG. 9. The assembly and structure of the foot frame portion 272 and foot panel portion 204 to form the foot lid 200A and of the head frame portion 282 and the head panel portion 214 to form the head lid 200B is thereafter provided in connection with FIG. 10.

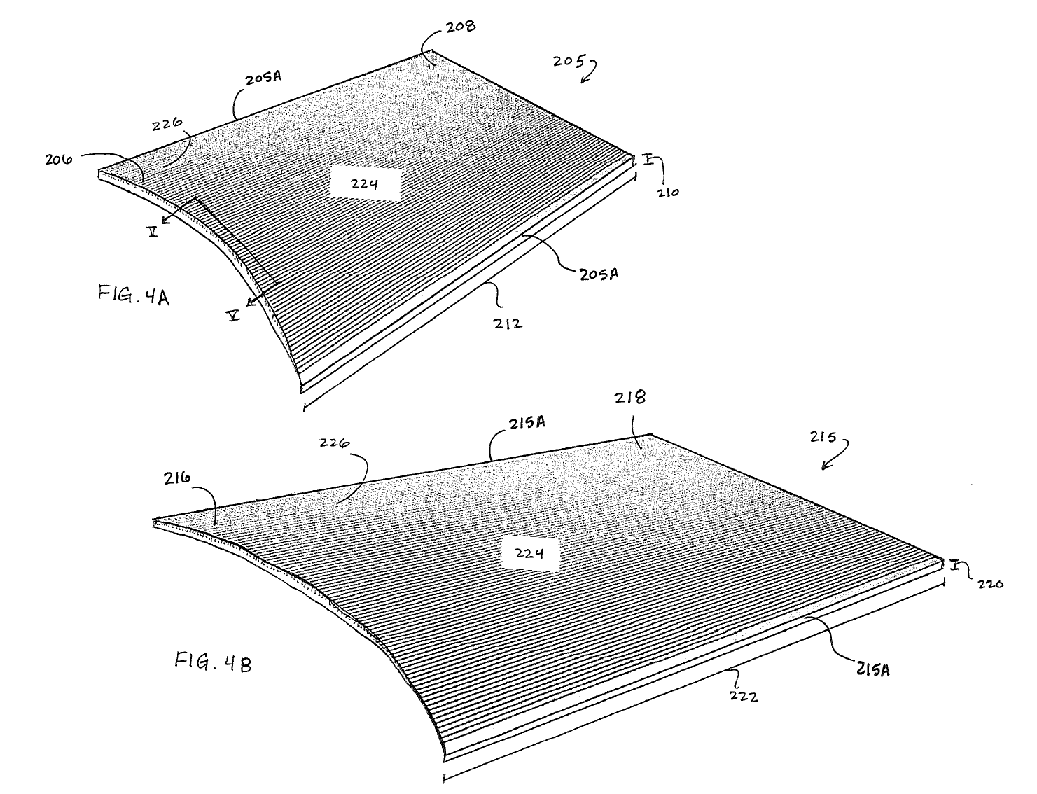

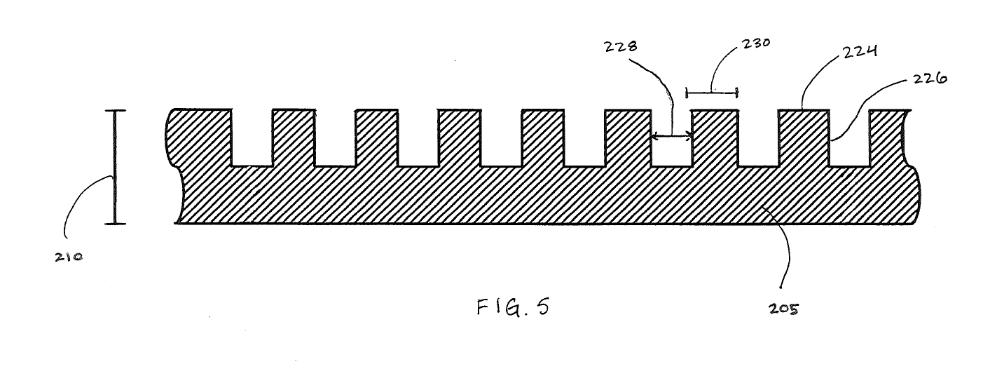

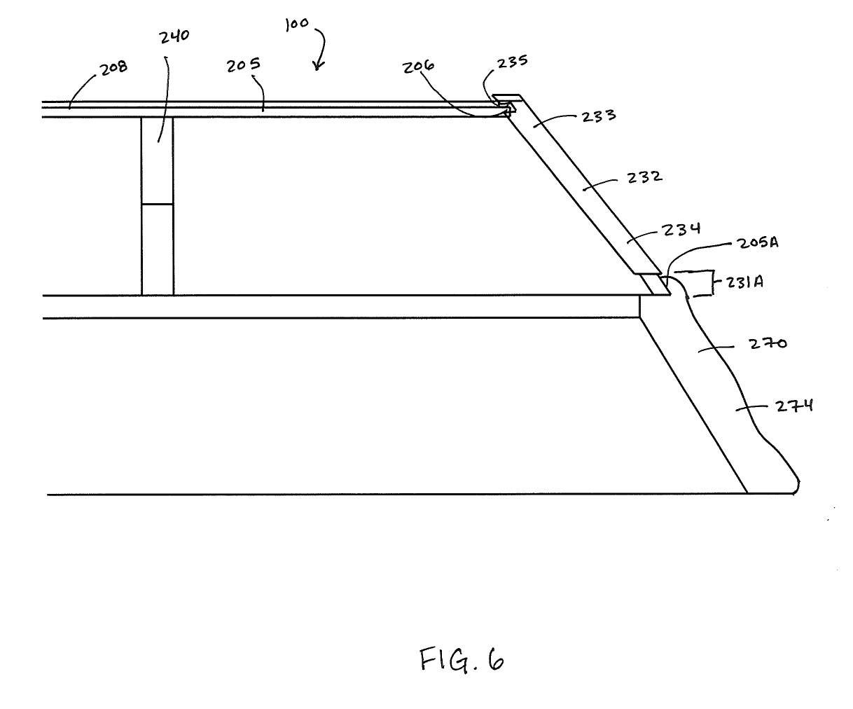

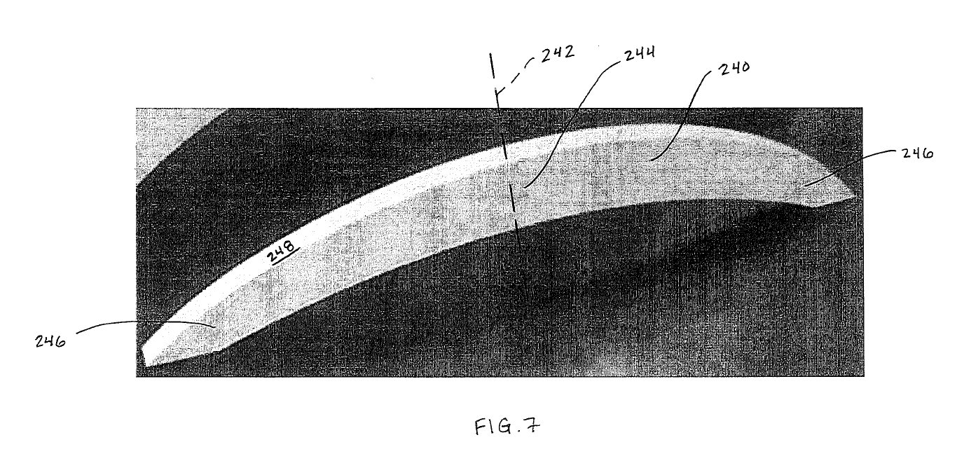

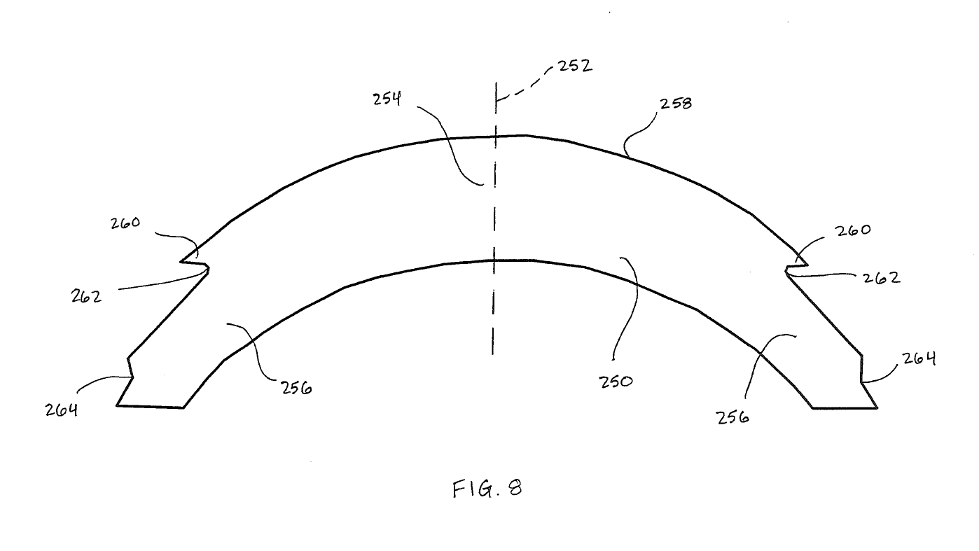

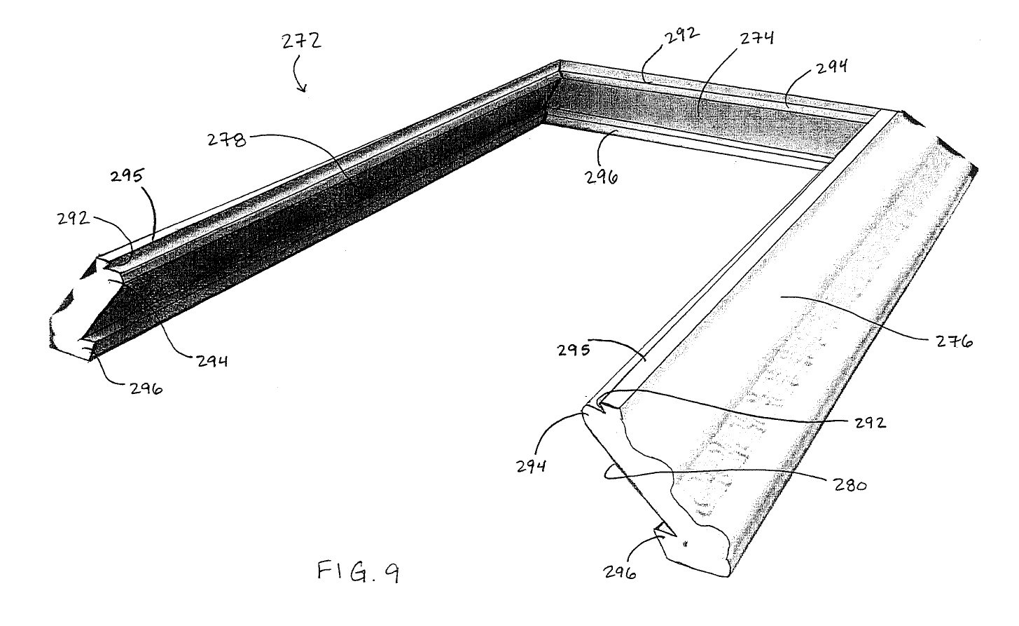

FIG. 3A depicts a bottom left perspective view of the foot panel portion 204 of the panel assembly 202. The foot panel portion 204 includes a foot panel 205, a foot end cover 232, two supports 240 and a brace 250. The foot panel 205 is discussed below in connection with FIG. 4A and FIG. 5. The foot end cover 232 is discussed below in connection with FIG. 6. The structure of the supports 240 is discussed below in further detail in connection with FIG. 7. The brace 250 is discussed below in further detail in connection with FIG. 8.

As shown in FIG. 4A, the foot panel 205 used in this embodiment is constructed of medium density fiberboard. It will be understood, however, that the foot panel 205 could alternatively be made out of another material with similar properties, so long as the foot panel 205 is flexible, durable, lightweight, aesthetically pleasing and suitable for cremation. The foot panel 205 includes an underside 224, a foot end 206, and a middle end 208 opposite the foot end 206. The foot panel 205 has a thickness 210, a length 212, and side edges 205A. FIG. 4A includes lines V indicating a cross-section of the foot panel 205 which is shown in FIG. 5.

As shown in FIG. 5, the underside 224 includes a plurality of scores 226 formed therein, for example, by cutting. The scores 226 do not pass through the entire panel thickness 210. Each score 226 defines a score width 228 and each score 226 is separated from the other scores 226 by a separation distance 230. The score width 228 is selected such that it will create enough void space on the underside 224 of the foot panel 205 to decrease its structural integrity and allow the foot panel 205 to bend into an arc shape. The scores 226 extend parallel to the length 212 (shown in FIG. 4A) of the foot panel 205 to facilitate bending the foot panel 205 along the length 212 into an arced shape such that the foot panel portion 204 will mate with the foot frame portion 272 to form the foot lid 200A when assembled as shown in FIGS. 2A-2C. The score width 228 may be, for example, approximately 0.125 inches. The separation distance 230 between the scores 226 is selected such that the underside 224 of the foot panel 205 will have enough non-void space to retain appropriate structural integrity. The separation distance 230 may be, for example, approximately 0.15 inches.

FIG. 6 depicts a fragmentary cross-sectional view of the foot end cover 232 taken along the line VI-VI of FIG. 2A. The foot end cover 232 of this embodiment is made out of wood. It will be understood however, that the foot end cover 232 can alternatively be made out of another rigid material, so long as the foot end cover 232 is durable, lightweight, aesthetically pleasing and suitable for cremation. The foot end cover 232 includes a foot end cover notch 235 which is sized and configured to receive the foot end 206 of the foot panel 205 to affix the foot end cover 232 to the foot panel 205 as shown in FIG. 6.

As shown in FIG. 3A, the foot end cover 232 is shaped substantially as a segment of a circle having an arced foot end cover top 233 and a straight foot end cover bottom 234. The arced shape of the foot end cover top 233 is configured such that the foot end cover 232 can match the curve of the foot panel 205 when affixed to the foot panel 205 as shown in FIG. 3A.

Returning to FIG. 6, when the foot end cover 232 is affixed to the foot panel 205, the foot end cover 232 is slanted so that the foot end cover top 233 is nearer to the middle end 208 of the foot panel 205 compared to the foot end cover bottom 234. Additionally, the foot end cover 232 does not extend all the way to the side edges 205A of the foot panel 205. Instead, a small gap 231A exists along the foot end 206 of the foot panel 205 past the end of the foot end cover bottom 234. Accordingly, when the foot end cover 232 is affixed to the foot panel 205, the foot end cover bottom 234 rests atop the frame assembly 270 rather than interlocking with the frame assembly 270.

As discussed above, FIG. 7 depicts a perspective view of one of the supports 240 of the foot panel portion 204. The support 240 of this embodiment is constructed of medium density fiberboard. It will be understood, however, that the support 240 may alternatively be made out of another rigid material, so long as the supports 240 are durable, lightweight, aesthetically pleasing and suitable for cremation. The support 240 is generally arc shaped and is symmetrical about a support centerline 242. The support 240 includes a medial support portion 244 and lateral support portions 246 adjacent to and on opposite sides of the medial support portion 244. The support 240 is wider at the medial support portion 244 and narrower at the lateral support portions 246. The support 240 includes a top support edge 248 which is a flat surface following the arced shape of the support 240. The top support edge 248 is configured such that the support 240 may be affixed to the underside 224 of the foot panel 205 as shown in FIG. 3A.

As also discussed above, FIG. 8 depicts a front elevational view of the brace 250 of the foot panel portion 204. The brace 250 of this embodiment is constructed of medium density fiberboard (MDF), but may be also constructed of wood, among other things. It will be understood, however, that the brace 250 may alternatively be made out of another rigid material, so long as the brace 250 is durable, lightweight, aesthetically pleasing and suitable for cremation. The brace 250 is generally arc shaped and is symmetrical about a brace centerline 252. The brace 250 includes a medial brace portion 254 centered about the brace centerline 252 and lateral brace portions 256 abutting the medial brace portion 254 on opposite sides of the centerline 252. The brace 250 is wider at the medial brace portion 254 and narrower at the lateral brace portions 256. The brace 250 also includes a top brace edge 258 which is a flat surface following the arced shape of the brace 250. The top brace edge 258 is configured such that the brace 250 may be affixed to the underside 224 of the foot panel 205 as shown in FIG. 3A.

Returning to FIG. 8, the brace 250 further includes a pointed overhang 260 on each lateral brace portion 256. The brace 250 further includes an upper indentation 262 on each lateral brace portion 256. Each upper indentation 262 is located below a pointed overhang 260. The brace 250 further includes a lower indentation 264 on each lateral brace portion 256. Each lower indentation 264 is located below an upper indentation 262.

Referring again to FIG. 3A, the components of the foot panel portion 204 described above are arranged in the following manner: the foot end cover 232 is coupled to the foot panel 205 at the foot end 206 (see also FIG. 6); the brace 250 is coupled to the underside 224 of the foot panel 205 at the middle end 208; and the two supports 240 are coupled to the underside 224 of the foot panel 205 in a spaced apart manner between the foot end 206 and the middle end 208.

While, the embodiment shown in FIG. 3A includes two supports 240 coupled to the underside 224 of the foot panel 205, it will be understood that in alternative embodiments, more or fewer than two supports 240 may be coupled to the underside 224 of the foot panel 205. Additionally, the embodiment shown in FIG. 3A depicts the supports 240 spaced substantially equidistantly between the foot end cover 232 and the brace 250. It will be understood, however, that in alternative embodiments, the supports 240 may be spaced at other intervals between the foot end cover 232 and the brace 250, so long as adequate support is provided along the length 212 of the foot panel 205.

As shown in FIGS. 2A-2C, the foot panel portion 204 is combined with the head panel portion 214 to form the panel assembly 202. The head panel portion 214, which is substantially the same in arrangement, configuration and function as the foot panel portion 204 shown in FIG. 3A and described above, is described in connection with FIG. 3B.

With reference to FIG. 3B, the head panel portion 214 includes a head panel 215, a head end cover 236, supports 240 and a brace 250. The head panel 215 is discussed below in connection with FIG. 4B and is substantially the same in arrangement, configuration and function as the foot panel 205 described above and shown in FIG. 4A. The head end cover 236 is discussed below in connection with FIG. 3B and is substantially the same in arrangement, configuration and function as the foot end cover 232 described above and shown in FIG. 3A and FIG. 6. The supports 240 and the brace 250 used in the head panel portion 214 are substantially identical to those used in the foot panel portion 204 described above and shown in FIG. 7 and FIG. 8, respectively. The head panel portion 214 in this embodiment differs from the foot panel portion 204 only in that the head panel 215 has a greater length than the foot panel 205.

Like the foot panel 205, the head panel 215 used in this embodiment is constructed of medium density fiberboard. It will be understood, however, that the head panel 215 could alternatively be made out of another material with similar properties, so long as the head panel 215 is flexible, durable, lightweight, aesthetically pleasing and suitable for cremation.

As shown in FIG. 4B, analogously to the foot panel 205, the head panel 215 includes an underside 224, a head end 216, and a middle end 218 opposite the head end 216. The head panel 215 also has a thickness 220, a length 222, and side edges 215A. The thickness 220 of the head panel 215 is the same as the thickness 210 of the foot panel. The length 222 of the head panel 215, however, is greater than the length 212 of the foot panel 205. The length 222 of the head panel 215 enables the head panel 215 to be lifted during a ceremony or viewing of the deceased and facilitates conventional presentation of the deceased. Although not shown, the cross-section of the head panel 215 is substantially identical in configuration, arrangement and function to the cross-section of the foot panel 205 described above in connection with FIG. 5.

Returning to FIG. 3B, analogously to the foot end cover 232, the head end cover 236 is shaped substantially as a segment of a circle having an arced head end cover top 237 and a straight head end cover bottom 238. The arced shape of the head end cover top 237 is configured such that the head end cover 236 can match the curve of the head panel 215 when affixed to the head panel 215 as shown in FIG. 3B. The head end cover 236 includes a head end cover notch (not shown, but substantially identical to the foot end cover notch 235 discussed above in connection with FIG. 6) which is sized and configured to receive the head end 216 of the head panel 215 to affix the head end cover 236 to the head panel 215 as shown in FIG. 3B.

Although not shown, the cross-section of the head end cover 236 is substantially identical in configuration, arrangement and function to the cross-section of the foot end cover 232 described above in connection with FIG. 6. Accordingly, when the head end cover 236 is affixed to the head panel 215, the head end cover bottom 238 rests atop the frame assembly 270 rather than interlocking with the frame assembly 270 (not shown, but substantially identical to the arrangement of the foot end cover 232 and the frame assembly 270 discussed above in connection with FIG. 6).

As shown in FIG. 3B, the components of the head panel portion 214 described above are arranged in the following manner: the head end cover 236 is coupled to the head end 216 of the head panel 215; the brace 250 is coupled to the underside 224 of the head panel 215 at the middle end 218; and the supports 240 are coupled to the underside 224 of the head panel 215 between the head end 216 and the middle end 218.

The embodiment shown in FIG. 3B includes three supports 240 coupled to the underside 224 of the head panel 215. In contrast with the two supports 240 used in the foot panel portion 204, three supports 240 are used in the head panel portion 214 because the length 222 of the head panel 215 is greater than the length 212 of the foot panel 205 (shown in FIG. 3A) and thus benefits from additional strength and stability provided by a third support 240. It will be understood, however, that in alternative embodiments, more or fewer than three supports 240 may be coupled to the underside 224 of the head panel 215. It will further be understood that the relative lengths of the panels 215, 205 may differ in other embodiments.

As discussed above, the foot panel portion 204 and the head panel portion 214 combine to form the panel assembly 202. It is noted that, when the foot panel portion 204 and the head panel portion 214 form the panel assembly 202 as shown in FIG. 2C, the foot end cover top 233 is closer to the head end cover top 237 than the foot end cover bottom 234 is to the head end cover bottom 238. This arrangement gives the panel assembly 202 an aesthetic tapered appearance. It is also noted that, when the foot panel portion 204 and the head panel portion 214 form the panel assembly 202, the braces 250 abut one another to provide structural support to the middle of the panel assembly 202 and to maintain structural support in the middle of the panel assembly 202 when the head panel portion 214 is open for partial presentation of the deceased.

As discussed above, the foot panel portion 204 and the head panel portion 214 of the panel assembly 202 are assembled onto the respective frame portions 272, 282 of the frame assembly 270 to form the lid 200. FIG. 9 shows the structure of the foot frame portion 272, apart from the remaining parts of the lid 200, in detail. It will be appreciated that the head frame portion 282 may suitably have the same structure, arrangement and function, except that the head frame portion 282 has additional length corresponding to the length 222 of the head panel portion 214.

Referring now to FIG. 9, the foot frame portion 272 includes the foot frame end 274, the front foot frame side 276 and the back foot frame side 278. The foot frame end 274 is coupled to the front foot frame side 276 and the back foot frame side 278 to form a general “U” shape with a foot frame opening 280 defined therebetween. The foot frame end 274, front foot frame side 276 and back foot frame side 278 have uniform cross-sections along their lengths defining a sculpted molding piece. The top surfaces of each of the front foot frame side 276 and the back foot frame side 278 include a cut-out 292 that faces inwardly. The cut-outs 292 define an upper ledge 294 and a corresponding inclined overhang 295. The overhang 295 extends partly over the upper ledge 294. The cut-outs 292, upper ledge 294 and the overhang 295 of the foot frame portion 272 are sized and configured to mate with corresponding features of the supports 240 and the braces 250 of the foot panel portion 204 of FIG. 3A, as is discussed further below.

Also shown in FIG. 9, the internal sides of the front foot frame side 276, the back foot frame side 278 and the foot frame end 274 also include a lower ledge 296 extending in a plane parallel to, and below, that of the upper ledge 294. The lower ledge 296 protrudes inwardly from the foot frame end 274, the front foot frame side 276, and the back foot frame side 278. The lower ledge 296 is sized and configured to mate with corresponding features of the braces 250 of the foot panel portion 204 of FIG. 3A, as is discussed further below.

In particular, FIG. 10 depicts a top left perspective view of the foot panel portion 204 coupled to the foot frame portion 272 to form the foot lid 200A. When the foot panel portion 204 is coupled to the foot frame portion 272, the brace 250 interlocks with the front foot frame side 276 and back foot frame side 278 of the foot frame portion 272. The pointed overhangs 260 of the lateral brace portions 256 fit within the cut-outs 292. Additionally, the upper ledges 294 on the head frame portion 278 fit within the upper indentations 262 on the brace 250 and the lower ledges 296 on the foot frame portion 272 fit within the lower indentations 264 on the brace 250. The relationships between the foot frame portion 272 and the brace 250 couple the foot panel portion 204 to the foot frame portion 272 in a manner which prevents the foot panel portion 204 from moving vertically relative to the foot frame portion 272. Accordingly, once the foot panel portion 204 has been inserted into the foot frame portion 272, the foot panel portion 204 and the foot frame portion 272 form a single cohesive unit such that lifting the foot frame portion 272 of the lid 200 relative to the base portion 102 (shown in FIG. 1A) results in the foot panel portion 204 also being lifted relative to the base portion 102.

The head frame portion 282 is configured and arranged in the same manner as the foot frame portion 272 except that the head frame portion 282 has a greater length than the foot frame portion 272 to accommodate the head panel 215 which has a greater length than the foot panel 205. As shown in FIGS. 2A-2C, the head frame portion 282 includes a head frame end 284 like the foot frame end 274 of the foot frame portion 272 in FIG. 9. The head frame portion 282 also includes a front head frame side 286 like the front foot frame side 276 of the foot frame portion 272 in FIG. 9. The head frame portion 282 also includes a back head frame side 288 like the back foot frame side 278 of the foot frame portion 272 in FIG. 9. Although not visible in FIG. 2A, the head frame portion 282 also includes a head frame opening 290 similar to the foot frame opening 280 of the foot frame portion 272. Thus, the head frame portion 282 has a substantially similar structure as the foot frame portion 272.

The head panel portion 214 is coupled to the head frame portion 282 to form the head lid 200B in the same manner as described above with reference to the assembly of the foot lid 200A. Thereafter, the foot lid 200A and the head lid 200B are assembled onto the casket base portion 102 as shown in FIGS. 2A-2C. The foot lid 200A and the head lid 200B can move independently of one another such that one portion of the lid 200 can be lifted relative to the base portion 102 (shown in FIG. 1A) while the other portion of the lid 200 is not lifted relative to the base portion 102.

When the lid 200 is assembled as shown in FIGS. 2A-2C, the braces 250 coupled to the foot panel portion 204 and the head panel portion 214 are in opposition to and abutting one another, the middle end 208 of the foot panel 205 and the middle end 218 of the head panel 215 are in opposition to and abutting one another, the front head frame side 286 is in opposition to and abutting the front foot frame side 276 and the back head frame side 288 is in opposition to and abutting the back foot frame side 278. When the lid 200 is placed on the base portion 102 as shown in FIGS. 1A-1C, the panel assembly 202 extends over the base portion 102 of the casket 100.

To assemble the lid 200 for use with the casket 100 as shown in FIGS. 1A-1C, the foot panel portion 204 and head panel portion 214 are assembled as shown in FIGS. 3A and 3B. To this end, the foot panel 205 and head panel 215 are bowed such that the undersides 224 are concave. The supports 240 and brace 250 are coupled to the underside 224 of the foot panel 205 and the foot end cover 232 is coupled to the foot end 206 of the foot panel 205. Likewise, the supports 240 and brace 250 are coupled to the underside 224 of the head panel 214 and the head end cover 236 is coupled to the head end 216 of the head panel 214.

With reference to FIG. 9, to assemble the foot frame portion 272, the foot frame end 274 is coupled to each of the front foot frame side 276 and the back foot frame side 278 such that the cut-outs 292, the upper ledges 294 and the lower ledges 296 on each of the front foot frame side 276, the back foot frame side 278 and the foot frame end 274 align. To assemble the head frame portion 282, the same process is applied as described with reference to the foot frame portion 272.

The foot panel portion 204 can then be coupled to the foot frame portion 272. To this end, the foot end 206 of the foot panel 205 is aligned with the foot frame portion 272 at the foot frame opening 280 (shown in FIG. 9). The foot end 206 of the foot panel 205 mates with the cut-out 292 (shown in FIG. 9). The foot panel 205 slides within the cut-out 292 along the front foot frame side 276 and the back foot frame side 278 of the foot frame portion 272 from the foot frame opening 280 toward the foot frame end 274 (shown in FIG. 9). When the supports 240 encounter the front foot frame side 276 and the back foot frame side 278, the lateral support portions 246 of the supports 240 (shown in FIG. 5) also align with and then slide within the cut-outs 292 of the foot frame portion 272 (shown in FIG. 9).

The sliding movement of the foot panel 205 into to the foot frame portion 272 toward the foot frame end 274 is limited by contact of the side edges 205A on the foot end 206 of the foot panel 205 with the cut-out 292 in the foot frame end 274. See FIGS. 6 and 9. Once the side edges 205A on the foot end 206 of the foot panel 205 contact the foot frame end 274, the foot panel 205 can slide no farther and the foot end cover 232 rests atop the foot frame end 274. The relationship between the foot end 206 of the foot panel 205 and the foot frame end 274 of the foot frame portion 272 couples the foot panel portion 204 to the foot frame portion 272 in a manner which prevents the foot panel portion 204 from moving farther along the foot frame portion 272 than the foot frame end 274. At this point, the foot lid 200A of the lid 200 is complete and is ready to be attached to the base portion 102 of the casket 100 (shown in FIG. 1A).

As noted above, the head panel portion 214 is arranged and configured and functions in the same way as the foot panel portion 204. Similarly, the head frame portion 282 is arranged and configured and functions in the same way as the foot frame portion 272. Accordingly, the head panel portion 214 and the head frame portion 282 are coupled together in the same way as the foot panel portion 204 is coupled to the foot frame portion 272. Thus, the head lid 200B of the lid 200 is arranged and configured and functions in the same way as the foot lid 200A. Once the head lid 200B is completed, the head lid 200B can be attached to the base portion 102 of the casket 100 (shown in FIG. 1A).

The lid 200 provides a casket lid made out of alternative materials that results in lower material and assembly costs. The dome shape of the panel assembly 202 efficiently accommodates the deceased within the casket 100. The materials and the configuration of the panel assembly 202 and the frame assembly 270 provide the lid 200 with sufficient structural integrity to withstand pressure applied to the top of the casket 100 during use. The lid 200 is constructed of low cost materials such as medium density fiberboard and wood and is simply assembled by sliding the foot panel portion 204 into the foot frame portion 272 and the head panel portion 214 into the head frame portion 282.

FIGS. 11A-11C depict an alternative embodiment in which a lid 300 consists of a panel assembly 302 having only one panel 303 and a frame assembly 370 having a frame end 374, a front frame side 376, a back frame side 378 and a frame opening 380. In this embodiment, the lid 300 also consists of a separate frame end 384 coupled to the panel assembly 302 and the frame assembly 370 after the panel assembly 302 is coupled to the frame assembly 370. Thus, the frame opening 380 is defined or accessible when the frame end 384 is removed. Although not all parts of the lid 300 are shown in FIGS. 11A-11C, unless described otherwise, the parts of the lid 300 are substantially the same and are arranged in substantially the same way as those described above with reference to lid 200.

In this embodiment, the panel assembly 302 is assembled and arranged in a similar manner as that described above with reference to foot panel portion 204. To this end, the panel assembly 302 includes a foot end cover 332, a head end cover 336, supports 340 and a brace 350 all coupled in the same manner as the corresponding lid 200 of FIGS. 2A-2C. The frame end 374 is coupled to the front frame side 376 and the back frame side 378. While the frame end 384 is removed, the panel 303 can be coupled to the frame assembly 370. The panel 303 is inserted into the frame assembly 370 through the frame opening 380 and is slid along the front frame side 376 and the back frame side 378 toward the frame end 374 until the edge (not shown) of the panel 303 below the foot end cover 232 contacts the frame end 374. The frame end 384 can then be inserted onto the front frame side 376 and the back frame side 378.

The panel 303, the foot end cover 332, the head end cover 336, the supports 340 and the brace 350 couple with the frame assembly 370 in the same manner as described above with reference to lid 200. In this embodiment, the brace 350 is spaced between the foot end cover 332 and the head end cover 336 and the supports 340 are spaced between the brace 350 and the foot end cover 332 and between the brace 350 and the head end cover 336. In particular, the panel 303 and lateral support portions (not shown, but substantially identical to the lateral support portions 246 discussed above in connection with FIG. 7) mate with the cut-outs (not shown, but substantially identical to the cut-outs 292 discussed above in connection with FIG. 9) on the frame assembly 370. The pointed overhangs of the brace (not shown, but substantially identical to the pointed overhangs 260 discussed above in connection with FIG. 8) mate with the cut-outs (not shown, but substantially identical to the cut-outs 292 discussed above in connection with FIG. 9) on the frame assembly 370, the upper indentations of the brace (not shown, but substantially identical to the upper indentations 262 discussed above in connection with FIG. 8) mate with the upper ledges (not shown, but substantially identical to the upper ledges 294 discussed above in connection with FIG. 9) on the frame assembly 370 and the lower indentations of the brace (not shown, but substantially identical to the lower indentations 264 discussed above in connection with FIG. 8) mate with the lower ledges (not shown, but substantially identical to the lower ledges 296 discussed above in connection with FIG. 9) on the frame assembly 370. In this embodiment, one brace 350 is included in the lid 300 to support the panel 303.

The panel 303 is fully received within the frame assembly 370 when the portion of the foot end 306 of the panel 303 extending below the foot end cover 332 (i.e., the edge of the panel 303) contacts the frame end 374. After the foot end 306 contacts the frame end 374, the separate frame end 384 is then coupled to the frame opening 380 such that the head end cover 336 rests atop the separate frame end 384. At this point, the foot end cover 332 rests atop the frame end 374 and the head end cover 336 rests atop the separate frame end 384 and the lid 300 is complete.

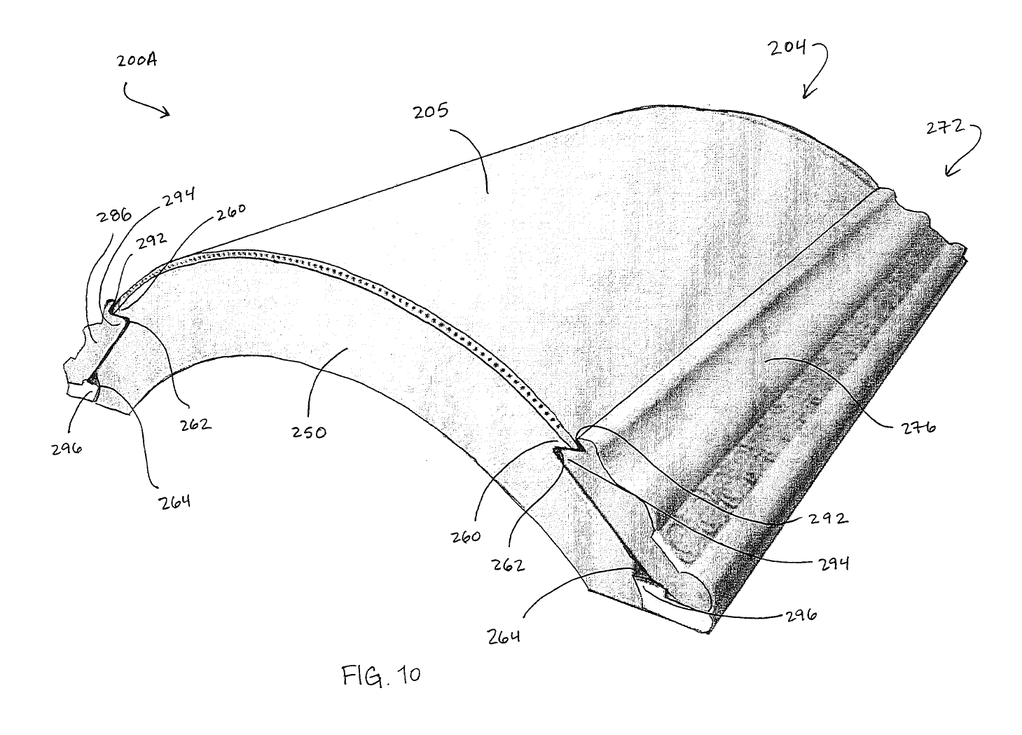

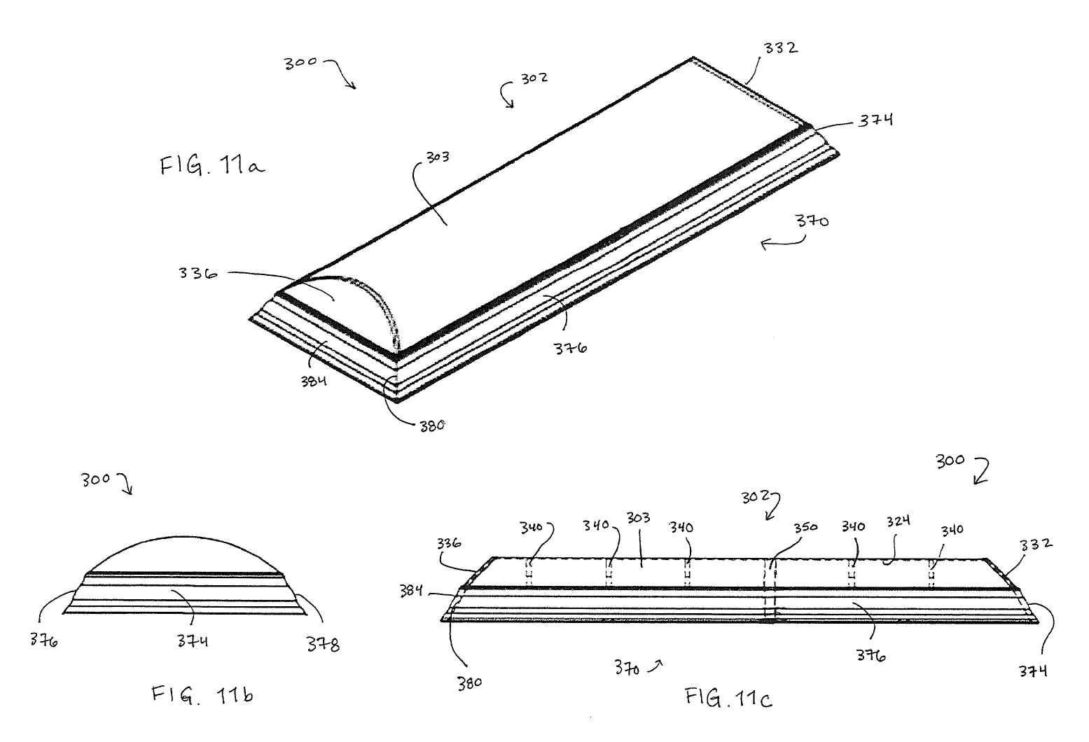

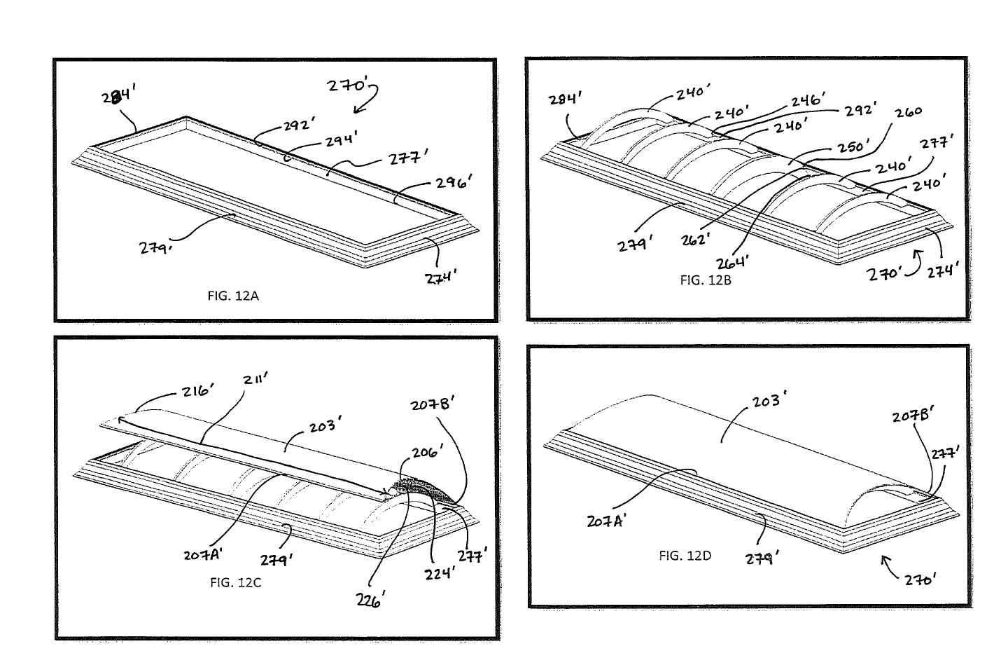

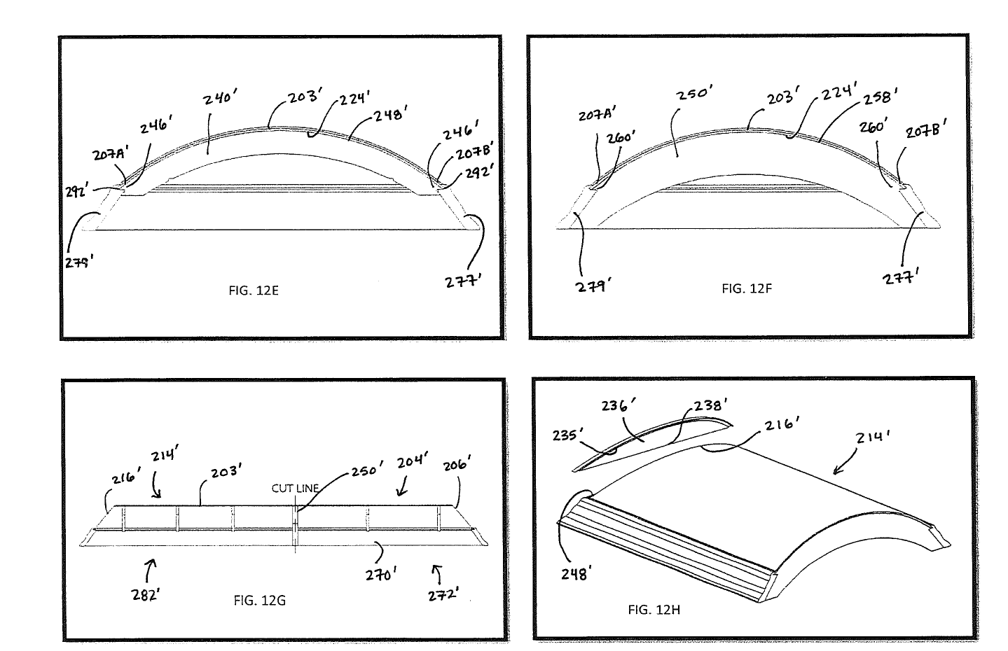

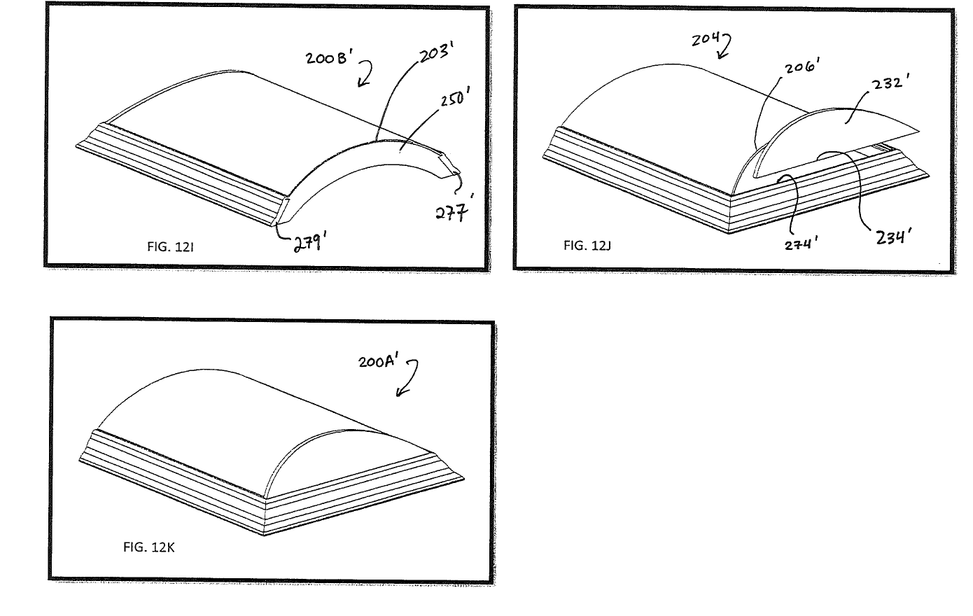

FIGS. 12A-12K depict an alternative method of assembling a lid for a casket. In this embodiment, as described below, the lid 200′ is constructed including a single panel 203′ and the frame assembly 270′ which are then cut to form the separate foot lid 200A′ and head lid 200B′. The lid 200′ is substantially identical in arrangement, configuration and function to the lid 200 shown in FIGS. 2A-2C. The lid 200′, however, is made using a method that differs from that used to make lid 200. To facilitate the different assembly method, the lid 200′ includes some elements different from those used to make lid 200. However, corresponding reference numbers will be used to identify parts that are substantially identical to those discussed above in connection with FIGS. 1-10.

As shown in FIG. 12A, in the method used to make lid 200′, the frame assembly 270′ is assembled first. The frame assembly 270′ includes a foot frame end 274′, a head frame end 284′, a back frame side 277′ and a front frame side 279′. Each of the portions of the frame assembly 270′ has mitered ends, and the portions of the frame assembly 270′ are assembled by joining the mitered ends together to form a single unit. As in the previously described embodiments, the portions of the frame assembly 270′ are joined so that the cut-outs 292′, the upper ledges 294′, and the lower edges 296′ align. It will be understood that the portions of the frame assembly 270′ can be coupled together in any order so long as the head frame end 284′ is opposite the foot frame end 274′, the front frame side 279′ is opposite the back frame side 277′ and the cut-outs 292′, upper ledges 294′, and lower edges 296′ align around the entire frame assembly 270′. The portions of the frame assembly 270′ can be fixed in relation to one another using any suitable method. For example, the portions of the frame assembly 270′ can be fixed together using adhesive and/or fastening devices.

As shown in FIG. 12B, next the supports 240′ and brace 250′ are coupled to the frame assembly 270′. The supports 240′ and brace 250′ are substantially identical to the supports 240 and the brace 250 described above and shown in FIG. 7 and FIG. 8, respectively. The supports 240′ are inserted into the frame assembly 270′ such that the lateral support portions 246′ fit within the cut-outs 292′ of the front frame side 279′ and the back frame side 277′. The brace 250′ is inserted into the frame assembly 270′ such that the pointed overhangs 260′ fit within the cut-outs 292′ of the front frame side 279′ and the back frame side 277′, such that the upper ledges 294 on the front frame side 279′ and the back frame side 277′ fit within the upper indentations 262′ on the brace 250′, and such that the lower ledges 296′ on the front frame side 279′ and the back frame side 277′ fit within the lower indentations 264′ on the brace 250′.

When coupled to the frame assembly 270′, the brace 250′ is positioned approximately 44 inches toward foot frame end 274′ from the head frame end 284′. Three supports 240′ are then spaced evenly between the brace 250′ and the head frame end 284′ and two supports 240′ are spaced evenly between the brace 250′ and the foot frame end 274′. The number and the spacing of supports 240′ shown in FIG. 12B is an exemplary number and spacing. It will be understood that the method could be performed with more or fewer supports 240′ spaced at different intervals than shown. The supports 240′ and brace 250′ are fixed to the frame assembly 270′ using any suitable method. For example, the supports 240′ and the brace 250′ can be fixed to the frame assembly 270′ using adhesive and/or fasteners, such as nails.

Once the supports 240′ and braces 250′ are assembled onto the frame assembly 270′, the single panel 203′ is coupled to the frame assembly 270′ and to the supports 240′ and the brace 250′. Referring to FIG. 12C, the single panel 203′ includes a foot end 206′, a front edge 207A′, a back edge 207B′, and a head end 216′. The single panel 203′ also has a length 211′ and an underside 224′. The single panel 203′ is arranged and configured in the same manner as the foot panel 205 described above and shown in FIG. 4A, except that the single panel 203′ is long enough to cover the entire frame assembly 270′. Thus, the underside 224′ includes scores 226′ substantially identical to the scores 226 of FIG. 3A and FIG. 5.

To couple the single panel 203′ to the frame assembly 270′, the single panel 203′ is flexed along its length 211′ drawing the front edge 207A′ toward the back edge 207B′ until both the front edge 207A′ and the back edge 207B′ can be inserted into the frame assembly 270′. As in the embodiments described above, the plurality of scores 226′ in the underside 224′ of the single panel 203′ enable the single panel 203′ to form a concave curve with the scores 226′ on the inside of the curve. In the embodiment shown in FIG. 12C, the back edge 207B′ of the single panel 203′ is inserted into the back frame side 277′ of the frame assembly 270′, and the single panel 203′ is then flexed so that the front edge 207A′ can be inserted into the front frame side 279′ of the frame assembly 270′. It will be understood that, alternatively, the single panel 203′ can be inserted into the frame assembly 270′ by first flexing the single panel 203′ and then inserting the front edge 207A′ of the single panel 203′ into the front frame side 279′ and the back edge 207B′ into the back frame side 277′. It is also understood that, as another alternative, the front edge 207A′ of the single panel 203′ can be inserted into the front frame side 279′ of the frame assembly 270′ and then the single panel 203′ can be flexed so that the back edge 207B′ can be inserted into the back frame side 277B′.

In any event, after the single panel 203′ is inserted into the frame assembly 270′ as shown in FIG. 12D, the front edge 207A′ of the single panel 203′ is received within the cut-out 292′ (shown in FIG. 12A) of the front frame side 279′ along with the lateral support portions 246′ of the supports 240′ (as shown in FIG. 12E) and the pointed overhang 260′ of the brace 250′ (as shown in FIG. 12F). Similarly, the back edge 207B′ of the single panel 203′ is received within the cut-out 292′ (shown in FIG. 12A) of the back frame side 277′ along with the lateral support portions 246′ of the supports 240′ (as shown in FIG. 12E) and the pointed overhang 260′ of the brace 250′ (as shown in FIG. 12F). Additionally, the underside 224′ of the single panel 203′ is in contact with the top support edges 248′ of the supports 240′ (as shown in FIG. 12E) and the top brace edge 258′ of the brace 250′ (as shown in FIG. 12F).

Because the single panel 203′ is curved to be inserted into the frame assembly 270′, the single panel 203′ is in a state of compression between the front frame side 279′ and the back frame side 277′. This compression acts as a force to bias the front edge 207A′ and the back edge 207B′ away from each other. Thus, the front edge 207A′ presses into the cut-out 292′ on the front frame side 279′ and the back edge 207B′ presses in the opposite direction into the cut-out 292′ on the back frame side 277′. These forces and the relative arrangement of the cut-outs 292′ on the frame assembly 270′ keep the single panel 203′ within the frame assembly 270′.

To further retain the single panel 203′ in the configuration shown in FIG. 12D, the underside 224′ of the single panel 203′ can be coupled to the top support edges 248′ of the supports 240′ (as shown in FIG. 12E) and the top brace edge 258′ of the brace 250′ (as shown in FIG. 12F). The single panel 203′ can be fixed relative to the supports 240′ and the brace 250′ using any suitable method. For example, the single panel 203′ can be fixed using adhesive and/or fasteners, such as nails.

After the single panel 203′ is coupled to the frame assembly 270′ as shown in FIG. 12D, the single panel 203′ and the frame assembly 270′ are cut along the brace 250′ as shown in FIG. 12G. In other words, the single panel 203′, the front frame side 279′, and the back frame side 277′ (shown in FIG. 12D) are cut approximately 44 inches toward the foot end 206′ of the single panel 203′ from the head end 216′ of the single panel 203′. The single panel 203′ is thus separated into a foot panel portion 204′ and a head panel portion 214′. The foot panel portion 204′ is substantially identical to the foot panel portion 204 described above and shown in FIG. 2C. Similarly, the head panel portion 214′ is substantially identical to the head panel portion 214 described above and shown in FIG. 2C. Likewise, the frame assembly 270′ is separated into a foot frame portion 272′ and a head frame portion 282′. The foot frame portion 272′ is substantially identical to the foot frame portion 272 described above and shown in FIG. 9. The head frame portion 282′ is substantially identical to the head frame portion 282 described above.

Next, as shown in FIG. 12H, the head lid 200B′ is completed by coupling the head end cover 236′ to the head end 216′ of the head panel portion 214′. The head end cover 236′ is substantially identical to the head end cover 236 described above and shown in FIG. 3B. The head end cover notch 235′ receives the head end 216′ of the head panel portion 214′ and the head end cover bottom 238′ rests atop the head frame end 284′. The resulting head lid 200B′ shown in FIG. 12I is substantially identical to the head lid 200B described above and shown in FIG. 2C.

In an additional step, a layer of veneer, not shown, is applied over the brace 250′ and the exposed end edges (as shown in FIG. 12I) of the single panel 203′, the front frame side 279′, and the back frame side 277′. The layer of veneer hides the otherwise exposed edges, and forms an aesthetic cover surface.

Similarly, as shown in FIG. 12J, the foot lid 200A′ is completed by coupling the foot end cover 232′ to the foot end 206′ of the foot panel portion 204′. The foot end cover 232′ is substantially identical to the foot end cover 232 described above and shown in FIG. 3A and FIG. 6. The foot end cover notch (not shown) receives the foot end 206′ of the foot panel portion 204′ and the foot end cover bottom 234′ rests atop the foot frame end 274′. The resulting foot lid 200A′ shown in FIG. 12K is substantially identical to the foot lid 200A described above and shown in FIG. 2C and FIG. 10.

The foregoing detailed description of one or more embodiments of the casket lid has been presented herein by way of example only and not limitation. It will be recognized that there are advantages to certain individual features and functions described herein that may be obtained without incorporating other features and functions described herein. Moreover, it will be recognized that various alternatives, modifications, variations or improvements of the above-disclosed embodiments and other features and functions, or alternatives thereof, may be desirably combined into many other different embodiments, systems or applications. Presently unforeseen or unanticipated alternatives, modifications, variations or improvements therein may be subsequently made by those skilled in the art which are also intended to be encompassed by the appended claims. Therefore, the spirit and scope of any appended claims should not be limited to the description of the embodiments contained herein.

What is claimed is:

1. A lid assembly for a casket comprising:
a panel extending over the casket, wherein the panel defines a length, the panel including an underside which faces toward the casket, the panel including a plurality of scores cut into the underside extending along the length to facilitate bending of the panel into an arced shape;
a first end portion coupled to a first end of the panel; and
a second end portion coupled to a second end of the panel.

2. The lid assembly of claim 1, wherein the panel defines a thickness of approximately 0.25 inches.

3. The lid assembly of claim 1, wherein at least one score of the plurality of scores defines a width of approximately 0.125 inches.

4. The lid assembly of claim 1, wherein at least one score of the plurality of scores is separated from another score of the plurality of scores by approximately 0.15 inches

5. The lid assembly of claim 1, wherein the panel is bowed such that the underside is concave.

6. The lid assembly of claim 5, further comprising at least one support, the at least one support including a top support edge, the top support edge coupled to the underside of the panel.

7. The lid assembly of claim 6, further comprising:
a brace defining;
a centerline, wherein the brace is substantially symmetrical about the centerline,
a medial portion centered about the centerline, and
lateral portions abutting the medial portion on opposite sides of the centerline,
the brace including a top brace edge, wherein the top brace edge is coupled to the underside of the panel, and
a frame including;
a first frame side and a second frame side,
at least one frame end, wherein the at least one frame end is coupled to the first frame side and the second frame side.

8. The lid assembly of claim 7, wherein the brace further includes a pointed overhang on each lateral portion and the frame further includes a cut-out, wherein the cut-out is configured to mate with the pointed overhang on each lateral portion of the brace.

9. The lid assembly of claim 8, wherein the brace further includes a first indentation on each lateral portion and the frame further includes a first protruding portion, wherein the first protruding portion is configured to mate with the first indentation on each lateral portion of the brace.

10. The lid assembly of claim 9, wherein the brace further includes a second indentation on each lateral portion and the frame further includes a second protruding portion, wherein the second protruding portion is configured to mate with the second indentation on each lateral portion of the brace.

11. The lid assembly of claim 7, wherein the brace is coupled to the underside of the panel between the first end portion and the second end portion.

12. The lid assembly of claim 11, wherein the panel further includes at least one support coupled to the underside between the brace and the first end portion.

13. The lid assembly of claim 12, wherein the panel includes two supports coupled to the underside between the brace and the first end portion.

14. The lid assembly of claim 11, wherein the panel further includes at least one support coupled to the underside between the brace and the second end portion.

15. The lid assembly of claim 14, wherein the panel includes three supports coupled to the underside between the brace and the second end portion.

16. A method of assembling a lid assembly for a casket comprising:
preparing a panel assembly;
preparing a frame assembly, wherein the frame assembly includes a first frame side, a second frame side, and a first frame end;
inserting the panel assembly into the frame assembly; and
coupling a second frame end to the frame assembly.

17. The method of claim 16, wherein;
preparing the panel assembly further includes cutting a plurality of scores in an underside of the panel and bowing the panel such that the underside is concave.

18. The method of claim 17, wherein;
preparing the panel assembly further includes coupling a first end portion and a second end portion to the bowed panel.

19. The method of claim 18, wherein;
preparing the panel assembly further includes coupling a brace to the underside of the bowed panel at a location between the first end portion and the second end portion.

20. The method of claim 19, wherein;
preparing the panel assembly further includes coupling supports to the underside of the bowed panel between the brace and the first end portion and between the brace and the second end portion.
